(19) United States
(12) Patent Application Publication
(10) Pub. No.: US 2006/0274010 A1
(43) Pub. Date: Dec. 7, 2006

(54) DSD LCD DRIVING METHOD AND DRIVING DEVICE THEREOF

(76) Inventors: Wing-Kai Tang, Hsinchu City (TW); Chien-Hsien Kao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,930

(22) Filed: May 26, 2006

(30) Foreign Application Priority Data
Jun. 7, 2005 (TW) 94118694

(51) Int. Cl. G09G 3/36

(52) U.S. Cl. 345/94

(57) ABSTRACT

A DSD display driving method and driving device thereof are provided. Each of the pixels of the display is selectively driven by a pair of select lines, and the polarities of the select signals can be alternately changed in accordance with different frame times. The driving method and the driving device thereof is adapted for balancing the asymmetric positive and negative polarities of conventional pixel voltages and efficiently preventing the flicker phenomenon in a conventional driving method.

### CROSS-REFERENCE TO RELATED APPLICATION

This application claims the priority benefit of Taiwan application serial no. 94118694, filed on Jun. 7, 2005. All disclosure of the Taiwan application is incorporated herein by reference.

### BACKGROUND OF THE INVENTION

1. Field of the Invention

The present invention relates to a display driving method and a driving device thereof, and particularly to a dual select diode (DSD) LCD driving method and a driving device thereof.

2. Description of Related Art

The operational principle of LCD is to provide an electric field to control the liquid crystal molecules for allowing the light to be passed or shielded. The active components, such as thin film transistors (TFTs) or field effect transistors (FETs), are used for controlling the switching ON/OFF of each pixel. When a scan signal is inputted for making the active component at a selected status (ON), signals to be displayed can be transferred to the pixel via the active component. Otherwise, if the active component is at a non-selected status (OFF), the signals to be displayed are temporarily stored in the pixels and wait to be driven for the next time. In other words, switching of the pixels are adapted for the purpose of accurately charging the liquid crystal (LC) capacitor to a data voltage level during the selected times and maintaining that voltage level for a short time during the non-selected times.

In a conventional LCD, the status of each pixel needs to be updated periodically within a certain period (for example at a frame rate 60 frame/sec). It is a necessary requirement, because for pixels the time to maintain or preserve their voltage levels of corresponding statuses is limited and also the frames tend to change in response to the display data. Therefore, how to rapidly switch the voltage levels or store the electric charge for a pixel and efficiently retain the electric charge lasting for at least a frame time is very important.

U.S. Pat. No. 4,731,610 disclosed a balanced drive electronic matrix system and a method of operating the same. According to the disclosure of the patent, a conventional DSD LCD driving method, in which each pixel is driven by a pair of diodes, or the dual select diode (DSD) is disclosed. Referring to FIG. 1, a schematic equivalent circuit diagram of a conventional pixel in an LCD is shown. The pixel structure 100 includes a pair of bidirectional diodes 110, 120 and an LC capacitor 130. Such a bidirectional diode has two threshold voltages which are equal in magnitude and opposite in polarity. The pixel structure 100 is connected with a pair of select lines SAn, SBn and a data line Di. The selection of the pixels is determined by the voltage levels of the select lines SAn, SBn, and the pixel data is inputted via data line Di.

When the LC capacitor 130 is to be charged, a positive voltage greater than the threshold voltage value of bidirectional diode 110 can be applied to a select line SAn; and a negative voltage lower than the threshold voltage value bidirectional diode 120 can be applied to a select line SBn, allowing current to flow via select lines SAn and SBn respectively and speeding up the charging of the LC capacitor 130. When the LC capacitor 130 is charged to a predetermined voltage value by a data voltage applied by a data line Di, two voltages which have absolute values less than the threshold voltage and opposite in polarity are respectively applied to the select lines SAn and SBn for efficiently storing charges in the LC capacitor 130.

According to such a LCD driving method and the driving device thereof, all voltages applied to select lines SAn (also referred to as upper select signal lines) are of positive polarity and all voltages applied to select lines SBn (also referred to as lower select signal lines) are of negative polarity. Therefore, referring to FIG. 2 that illustrating the pixel equivalent circuit structure, an inaccuracy or deviation in the pixel fabricating process may cause an equivalent resistor 140 between the bidirectional diode 120 and the LC capacitor 130, a voltage difference ΔVp being retained across the equivalent resistor 140. Also, referring to FIG. 3 that schematically shows the select lines SAn, SBn, the data voltage Vdata applied to the data line Di, and the voltage value Vlc stored in the LC capacitor 130, the equivalent resistor 140 may result in bias between the predetermined data voltage Vdata and the voltage Vlc stored in the LC capacitor 130. Such a pixel voltage driving of asymmetric positive polarity and negative polarity may cause displaying flickers of the LCD.

### SUMMARY OF THE INVENTION

An object of the invention is to provide a driving circuit and a driving method, adapted for efficiently solving the problem of asymmetric positive and negative polarities caused by imprecision or deviation in pixel fabricating process of an LCD.

Another object of the invention is to provide a driving circuit and a driving method, adapted for a display, wherein the display comprises a plurality of pixels arranged in the form of a matrix, wherein each of the pixels is selectively driven by a first select line and a second select line, and the display data is transmitted to the pixel via a data line. The voltages applied to the first select line and the second select line can be alternately changed in a time interval of a certain number of frame times without limitation of the voltage polarities to be positive or negative; therefore the problem of asymmetric positive and negative polarities in the frame times that is caused by deviation of the fabricating process can be prevented.

In an embodiment, the present invention provides a driving method, adapted for driving a pixel via a first select line and a second select line. The driving method includes alternately changing the polarities of the voltages respectively applied to the first select line and the second select line when the polarities are updated in every frame, so as to complement the polarities of the voltages respectively applied to the first select line and the second select line.

According to the foregoing driving method, a predetermined rule is followed to change the polarities of the voltages respectively applied to the first select line and the second select line. According to an embodiment, the predetermined rule is to change the polarities of the applied voltages within a certain number of frame times. According to another embodiment, the predetermined rule is to change the polarities of the voltages applied within a specific number of row times.

According to the foregoing driving method, the polarities of the voltages respectively applied to the first select line and the second select line are changed in a random manner. According to an embodiment, the random manner is to change the polarities of the applied voltages within a random number of frame times. According to another embodiment, the random manner is to change the polarities of the applied voltages within a random number of row times.

According to another embodiment, the invention provides a driving method, adapted for a matrix driving display, comprising a plurality of pixels arranged in the form of a matrix, wherein each of the pixels is selectively driven by a first select line and a second select line, the display data being transferred to the pixel via a data line. The driving method includes alternately changing the polarities of the voltages respectively applied to the first select line and the second select line when the polarities of voltages applied to the data lines is updated in every frame, so as to complement the polarities of the voltages respectively applied to the first select line and the second select line.

According to the foregoing driving method, a predetermined rule is followed to change the polarities of the voltages respectively applied to the first select line and the second select line. According to an embodiment, the predetermined rule is to change the polarities of the applied voltages within a certain number of frame times. According to another embodiment, the predetermined rule is to change the polarities of the voltages applied within a specific number of row times.

According to the foregoing driving method, the polarities of the voltages respectively applied to the first select line and the second select line are changed in a random manner. According to an embodiment, the random manner is to change the polarities of the applied voltages within a random number of frame times. According to another embodiment, the random manner is to change the polarities of the applied voltages within a random number of row times.

According to the foregoing driving method, the polarity of those voltages applied to all of the first select lines of an identical frame are positive or negative, so as to complement the polarities of the voltages respectively applied to the first select line and the second select line.

According to the foregoing driving method, the polarities, including positive and negative, of those voltages applied to all of the first select lines of an identical frame are regularly distributed, so as to complement the polarities of the voltages respectively applied to the first select line and the second select line.

According to the foregoing driving method, the polarities, including positive and negative, of those voltages applied to all of the first select lines of an identical frame are regularly distributed, all of the odd first select lines being applied with voltages having a positive polarity, all of the even first select lines being applied with voltages having a negative polarity, so as to complement the polarities of the voltages respectively applied to the first select line and the second select line.

According to another embodiment, the invention provides a driving circuit for a matrix driving display. The driving circuit is connected with a display panel, the display panel being composed of a plurality of pixels arranged in the form of a matrix, wherein each of the pixels is selectively driven by a first select line and a second select line, the display data being transferred to the pixel via a data line. The driving circuit includes a shift register, an enable selecting unit, a level shifter, a multiplexer, and an output buffer. The shift register includes a plurality of address channels adapted for receiving scan signals and storing the scan signals in the address channels according to a timing pulse signal. The enable selecting unit is adapted for receiving an enable signal and thereby transferring the scan data stored in the address channels of the shift register. The level shifter is connected with the enable selecting unit for receiving the transferred scan data from the address channels of the shift register and processing level shifting. The multiplexer is adapted for selectively outputting the level shifted scan data from the level shifter. The output buffer is adapted for receiving the level shifted scan data from the multiplexer and driving the pixel via a first select line and a second select line corresponding to the pixel, wherein the polarities of the voltages respectively applied to the first select line and the second select line can be alternately changed when the polarities of each frame are updated, so as to complement the polarities of the voltages respectively applied to the first select line and the second select line.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional LCD pixel equivalent circuit.

FIG. 2 is a schematic diagram of an LCD pixel equivalent circuit formed in an inaccurate fabricating process.

FIG. 3 is a schematic diagram of voltage levels of select signals according to a conventional LCD driving method.

FIG. 4A is a schematic diagram of a pixel equivalent circuit structure of a matrix driving display applying the driving method according to the embodiment of the invention.

FIG. 4B is a schematic diagram of voltage levels of select signals of the driving method according to the embodiment of the invention.

FIG. 5 is a schematic waveform diagram of the driving voltages according to the driving method of an embodiment of the invention.

FIG. 6 is a schematic waveform diagram of the driving voltages according to the driving method of another embodiment of the invention.

FIG. 7 is a schematic diagram of a matrix driving display applying a driving method according to an embodiment of the invention.

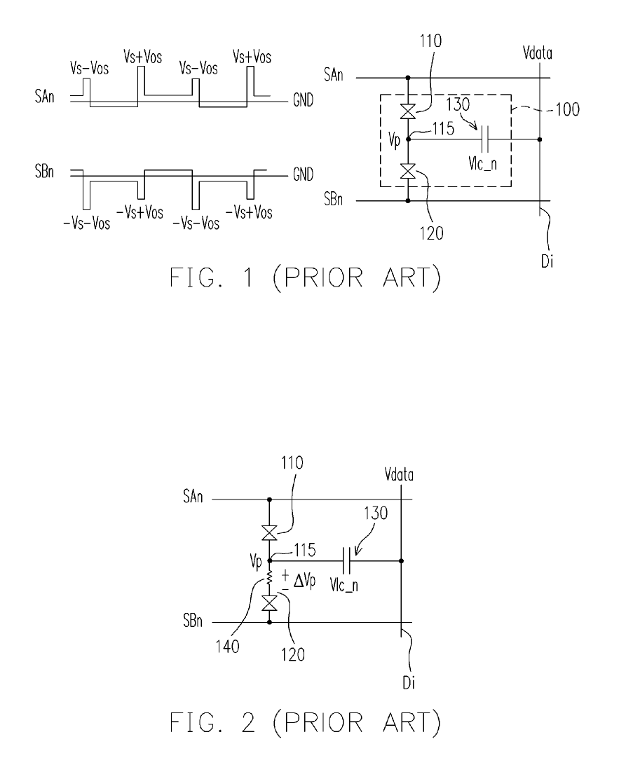

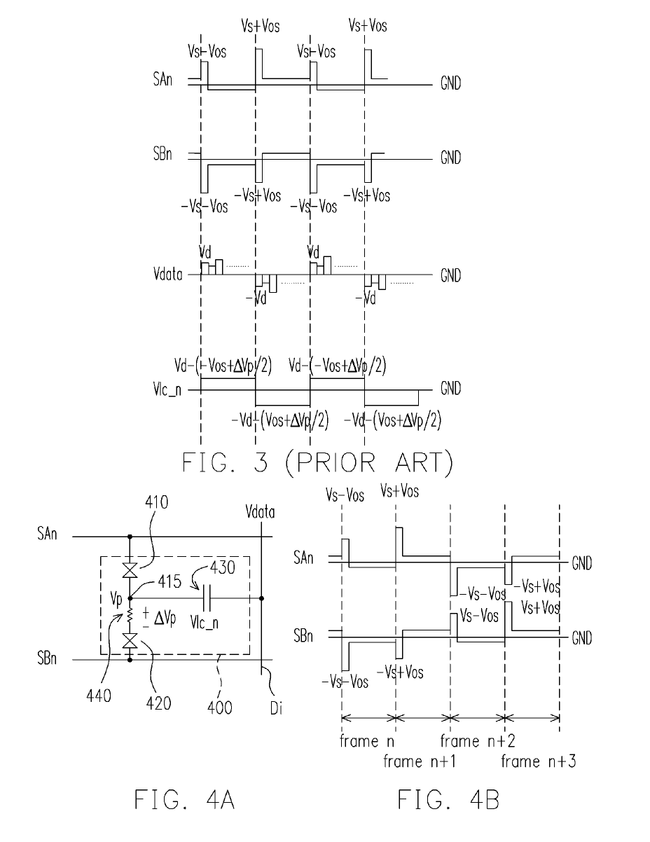

### DESCRIPTION OF THE EMBODIMENTS

The present invention provides a driving method, adapted for a matrix-type driving display, the matrix-type driving display being composed of a plurality of pixels arranged in a matrix. Each of the pixels is selectively driven by a first select line and a second select line, the display data being transferred to the pixel via a data line.

The driving method includes alternately changing the polarities of the voltages respectively applied to the first select line and the second select line when the polarities for each frame are updated, and the polarities of the voltages respectively applied to the first select line and the second select line are complementary. The polarities of the voltages respectively applied to the first select line and the second select line are changed in a predetermined rule or in a random manner. According to one embodiment, the predetermined rule is to change the polarities of the applied voltages within a time interval of a certain number of frame times. According to another embodiment, the predetermined rule is to change the polarities of the voltages applied within a specific number of row times. According to one embodiment, said random manner is to change the polarities of the applied voltages within a time interval of a random number of frame times. According to another embodiment, the random manner is to change the polarities of the applied voltages within a random number of row times.

In the driving method of the present invention, the polarity of those voltages applied to all of the first select lines for an identical frame can be positive, and the second select lines are applied with the voltages of complementary polarity. In an embodiment of the invention, the positive and negative polarities of those voltages applied to all of the first select lines for an identical frame are regularly distributed, and the second select lines are applied with the voltages of complementary polarity.

According to an embodiment of the invention, when the positive and negative polarities of those voltages applied to all of the first select lines for an identical frame are regularly distributed, all of the odd first select lines are applied with voltages of positive polarity and all of the even first select lines are applied with voltages of negative polarity, and also the second select lines are applied with the voltages of complementary polarity.

The embodiments are given below for illustrating the invention in detail.

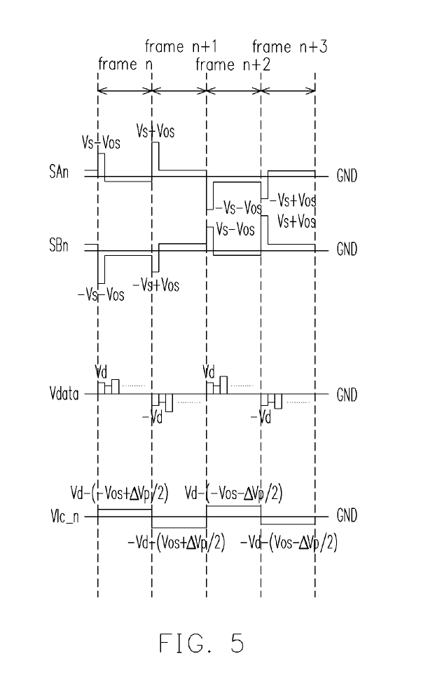

FIG. 4A is a schematic diagram of a equivalent circuit structure of a pixel in a matrix-type driving display applying the driving method according to the embodiment of the invention. Referring to FIG. 4A, the pixel structure 400 includes a pair of bidirectional threshold voltage device 410 and 420, and an equivalent capacitor 430. Each of the bidirectional threshold voltage devices 410 and 420 used for example has two threshold voltages, which are substantially equal in magnitude and opposite in polarity. According to an embodiment, the bidirectional threshold voltage devices 410 and 420 for example can be composed of bidirectional diodes, or in another embodiment they can be components having threshold voltages such as a thin film transistor (TFT), depending on the design requirement. And the equivalent capacitor 430 for example can be an liquid crystal (LC) capacitor when applied in a TFT-LCD.

The pixel structure 400 is connected with n^{th} select lines SAn and SBn and i^{th} data line Di, wherein the values of n and i are determined according to the structure of the display. The selection of the pixels is determined by the electric potential of the select lines SAn and SBn, and the pixel data is inputted via the data line Di.

When the equivalent capacitor 430 is to be charged, voltages can be applied to select lines SAn (also referred to as upper select signal line) and SBn (also referred to as lower select signal line) to accelerate the charging of the equivalent capacitor 430. When the equivalent capacitor 430 is charged to a predetermined voltage value with a data voltage applied via the data line Di, the pair of voltages whose absolute values less than the threshold voltage and opposite in polarity are respectively applied to the select lines SAn and SBn for efficiently storing the charges in the equivalent capacitor 430.

According to an embodiment of the driving method for the matrix-type driving display provided by the invention, the polarities of the voltages respectively applied to the first select line SAn and the second select line SBn can be alternately changed, without being limited to positive or negative polarity, within a time interval of a certain number of frame times, when the polarity of the data voltage applied by the data line Di is updated per frame. And all of the select lines SAn (n ranges from 1 to N where N represents the number of the horizontal display lines) or all of the select lines SBn are identical in polarity during an identical frame time, respectively. According to an aspect of the embodiment, within a time interval of four frame times, two voltages of positive polarity and two voltages of negative polarity can be applied to all of the upper select lines SAn or all of the lower select lines SBn, and necessarily, the polarities of the voltage applied to the upper select lines and the lower select lines are opposite.

FIG. 4B is a schematic diagram of voltage levels of the select signals of the driving method according to the embodiment of the invention. Referring to FIG. 4B, the voltage levels of the select signals applied to the select lines SAn and SBn are shown. It can be seen that within a time interval of every four frame times, the voltage levels applied to the select line SAn are Vs−Vos, Vs+Vos, −Vs−Vos, and −Vs+Vos, wherein the voltages of the first two frame times (frame n and frame n+1) are positive in polarity and the voltages of the last two frame times (frame n+2 and frame n+3) are negative in polarity; and the voltage levels applied to the select line SBn are −Vs−Vos, −Vs+Vos, Vs−Vos, and Vs+Vos, wherein the voltages of the first two frame times (frame n and frame n+1) are negative in polarity and the voltages of the last two frame times (frame n+2 and frame n+3) are positive in polarity. Wherein, Vs is the voltage of select signals, Vos is the bias voltage, and GND represents logical ground voltage which can be zero volt or adjusted according to design requirement.

According to the equivalent circuit structure of a pixel applying the driving method in the embodiments in FIGS. 4A and 4B, a slight imprecision in the pixel fabricating process may result in defects. For example, an equivalent resistor 440 may be formed, which causes a voltage difference ΔVp across the intersection point 415 of the bidirectional threshold voltage component 420 and the equivalent capacitor 430 and the bidirectional threshold voltage component 420. As to this, basing on the present invention, because the voltages applied to the select line SAn and the select line SBn can be alternately changed in a certain number of frame times without being limited to positive or negative polarity, the problem of asymmetric polarities caused by fabrication imprecision can be solved and the flicker phenomenon of the display can be avoided accordingly.

The equivalent resistor 440 caused by the inaccurate pixel fabricating process mentioned here is merely an example for illustrating the characteristics of the present embodiment of the present invention, but the inaccuracy may also cause another equivalent resistor for example between the bidirectional threshold voltage component 410 and the equivalent capacitor 430 or other problems, all of which can be solved via alternately applying voltages having opposite polarities to the select lines SAn and SBn within a certain number of frame times, and the asymmetric positive and negative polarities caused by the inaccuracy can be eliminated.

For better illustrating and comparing the driving method according to the embodiment of the invention and the conventional driving method, please refer to Table 1 and 2 as below.

TABLE 1

| | FRAME(n + 1) | | | FRAME(n + 2) | | | FRAME(n + 3) | | | FRAME(n + 4) | | | . . . |
|---|---|---|---|---|---|---|---|---|---|---|---|---|---|
| | Vd | Vp | Vlc | Vd | Vp | Vlc | Vd | Vp | Vlc | Vd | Vp | Vlc | . . . |
| The x^{th} | 2.5 | −2.5 | 5 | −2.5 | 3.5 | −6 | 2.5 | −2.5 | 5 | −2.5 | 3.5 | −6 | . . . |
| select line | | | | | | | | | | | | | |

TABLE 2

| | FRAME(n + 1) | | | FRAME(n + 2) | | | FRAME(n + 3) | | | FRAME(n + 4) | | | . . . |
|---|---|---|---|---|---|---|---|---|---|---|---|---|---|
| | Vd | Vp | Vlc | Vd | Vp | Vlc | Vd | Vp | Vlc | Vd | Vp | Vlc | . . . |
| The x^{th} | 2.5 | −2.5 | 5 | −2.5 | 3.5 | −6 | 2.5 | −3.5 | 6 | −2.5 | 2.5 | −5 | . . . |
| select line | | | | | | | | | | | | | |

Herein, suppose the voltage of the select signal Vs=15V; the bias voltage Vos=3V; the data voltage Vd=2.5V; and the pixel voltage difference Vp=1V, for example, and wherein Vp is the voltage of the intersection point 415 between the bidirectional threshold voltage components 410, 420 and the equivalent capacitor 430.

From the Table 1 and 2, the pixel voltage changes in different frames in the conventional driving method and that in the driving method of the embodiment of the invention can be seen. For the conventional driving method shown in Table 1, the pixel voltage changes in a sequence of 5V, −6V, 5V, −6V, etc; otherwise, according to the driving method of the embodiment shown in Table 2, the pixel voltage changes in a sequence of 5V, −6V, 6V, −5V etc. In this embodiment, by alternately applying voltages with opposite polarities to the select lines SAn and SBn within a certain number of frame times, the problem of asymmetric polarities (i.e. positive and negative polarities) caused by inaccurate pixel fabricating process can be solved.

In order to further explain in more detail the embodiment of alternately applying voltages with opposite polarities to the select lines SAn and SBn within a certain number of frame times, please refer to FIG. 5, a schematic waveform diagram of the driving voltages according to the driving method of an embodiment of the invention. In every four frame times, namely frame n, frame n+1, frame n+2 and frame n+3 as shown in FIG. 5, the voltage levels applied to the select line SAn are Vs−Vos, Vs+Vos, −Vs−Vos, and −Vs+Vos, wherein the voltages for the first two frame times (frame n and frame n+1) are positive in polarity and the voltages for the last two frame times (frame n+2 and frame n+3) are negative in polarity. The voltage levels applied to the select line SBn are −Vs−Vos, −Vs+Vos, Vs−Vos, and Vs+Vos, wherein the voltages for the first two frame times (frame n and frame n+1) are negative in polarity and the voltages for the last two frame times (frame n+2 and frame n+3) are positive in polarity. The data voltages Vdata are changed in the sequence of polarity inversion frame by frame, namely Vd, −Vd, Vd, −Vd; and the pixel voltages Vlc are changed in the sequence of Vd−(−Vos+ΔVp/2), −Vd−(Vos+ΔVp/2), Vd−(−Vos−ΔVp/2), and −Vd−(Vos−ΔVp/2). Wherein, the voltage difference ΔVp represents a supposed voltage difference caused by an inaccurate process, such as the foregoing equivalent resistor, Vs is the voltage of select signals, Vos is the bias voltage, and GND represents a logical ground voltage, which can be zero volt or adjusted according to design requirement. By summing up the four pixel voltage values, it can be seen that the driving method of the embodiment can efficiently solve the problem of asymmetric positive and negative polarities caused by an inaccurate process and further avoid the flicker phenomenon.

The foregoing embodiment is one example taken for illustrating the present invention, and wherein for the select line SAn voltage levels of the first two frames are positive polarity and voltage levels of the last two frames are negative polarity, and for the select line SBn voltage levels of the first two frames are negative polarity and voltage levels of the last two frames are positive polarity. However, according to another embodiment, only if the voltage levels applied to the select lines SAn and SBn are substantially equal in magnitude and opposite in polarity, the asymmetric positive and negative polarities caused by an inaccurate fabricating process can then be prevented accordingly. Moreover, voltages having different polarities can also be applied to the select lines SAn and SBn within frame times of other numbers instead of four frame times, for example six or eight frame times, depending on the frame refresh frequency. The only requirement is that the voltage difference caused by the asymmetric positive and negative polarities is able to be eliminated within that specific number of frame times.

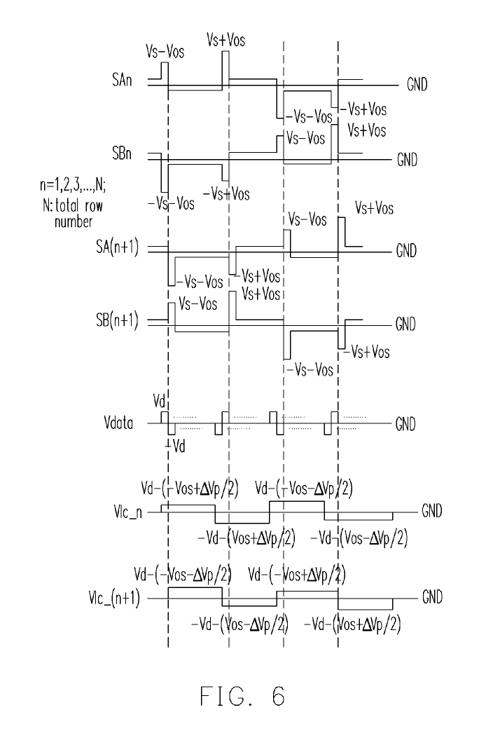

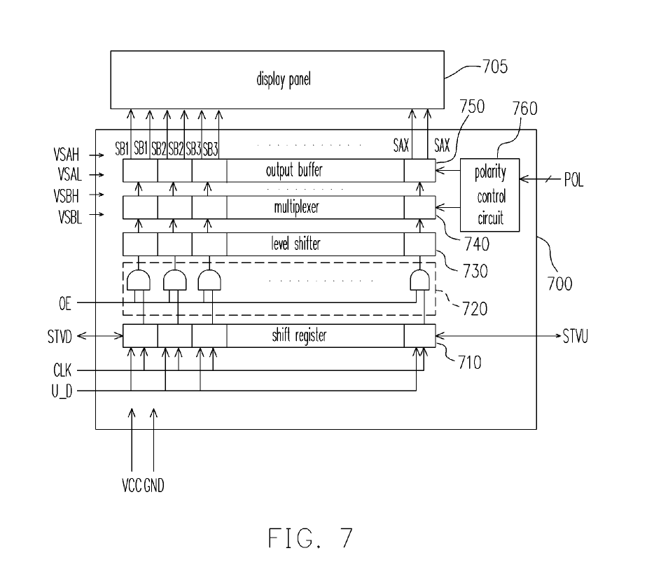

In order to further illustrate in more detail the embodiment of alternately applying voltages having opposite polarities to the select lines SAn and SBn within a certain number of frame times, please refer to FIG. 6, a schematic waveform diagram of the driving voltages according to the driving method of another embodiment of the invention. All of the select lines SAn and SBn can be divided into odd and even select lines, wherein different combinations of voltages can alternately applied to the odd select lines and the even select lines within each four frame times for achieving the purpose of the invention.

As shown in FIG. 6, all of the upper select lines are divided into odd upper select lines SAn′ and even upper select lines SAn″. Suppose that there are N lines of upper select lines, wherein n=1, 3, 5, . . . , N−1; n′=2, 4, 6, . . . , N; all of the lower select lines are divided into odd lower select lines SBn′ and even lower select lines SBn″. Suppose there are N lines of lower select lines, wherein n=1, 3, 5, . . . , N−1; n′=2, 4, 6, . . . , N.

Within every four frame times, namely frame n, frame n+1, frame n+2 and frame n+3 as shown, the voltage levels applied to the odd select lines SAn are Vs−Vos, Vs+Vos, −Vs−Vos, and −Vs+Vos, wherein the voltages for the first two frame times (frame n and frame n+1) are positive polarity and the voltages for the last two frame times (frame n+2 and frame n+3) are negative polarity; the voltage levels applied to the even select line SAn′ are −Vs−Vos, −Vs+Vos, Vs−Vos, and Vs+Vos, wherein the voltages for the first two frame times are negative polarity and the voltages for the last two frame times are positive polarity.

Also, within every four frame times, namely frame n, frame n+1, frame n+2 and frame n+3 as shown, the voltage levels applied to the odd select lines SBn′ are −Vs−Vos, −Vs+Vos, Vs−Vos, and Vs+Vos, wherein the voltages for the first two frame times (frame n and frame n+1) are negative polarity and the voltages for the last two frame times (frame n+2 and frame n+3) are positive polarity; the voltage levels applied to the even select line SBn″ are Vs−Vos, Vs+Vos, −Vs−Vos, and −Vs+Vos, wherein the voltages for the first two frame times are positive polarity and the voltages for the last two frame times are negative polarity.

The data voltages Vdata are changed in the sequence of polarity inversion frame by frame, namely the polarity inversion between Vd and −Vd. The data voltages of frame n, frame n+1, frame n+2 and frame n+3 are respectively changed from Vd, −Vd, Vd, −Vd to −Vd, Vd, −Vd, Vd.

The pixel voltages Vlc in response to the odd select lines SAn′ and SBn′ are changed in the sequence of Vd−(−Vos+ΔVp/2), −Vd−(Vos+ΔVp/2), Vd−(−Vos−ΔVp/2), −Vd−(Vos−ΔVp/2); and the pixel voltages Vlc in response the even select lines San′ and SBn′ are changed in the sequence of Vd−(−Vos−ΔVp/2), −Vd+(Vos−ΔVp/2), Vd−(−Vos+ΔVp/2), −Vd−(Vos+ΔVp/2). Wherein the voltage difference ΔVp represents a supposed voltage difference caused by an inaccurate pixel fabricating process, such as the foregoing equivalent resistor, Vs is the voltage of select signals and Vos is the bias voltage, and GND represents a logical ground voltage which can be zero volt or adjusted according to design requirement. By summing up the four pixel voltage values, the driving method of the embodiment can efficiently eliminate the asymmetric polarities caused by an inaccurate pixel fabricating process and further avoid the flicker phenomenon.

FIG. 7 is a schematic diagram of a driving circuit for a matrix-type driving display applying the driving method according to an embodiment of the invention. Referring to FIG. 7, the driving circuit 700 is connected to the display panel 705. In this matrix-type driving display, each pixel of the display panel 705 is selectively driven by a pair of select lines SAn and SBn, like SA1, SB1, SA2, SB2 . . . to SAX, SBX as shown, wherein X is the number of address channels. The driving circuit 700 includes a shift register 710, an enable selecting unit 720, a level shifter 730, a multiplexer 740 and an output buffer 750. The driving circuit 700 may further include a polarity control circuit 760 connected with the multiplexer 740 and the output buffer 750 for controlling polarity switching according to received polarity switch signals POL.

The shifter register 710 has a plurality of address channels, adapted for receiving scan start signals (“STVD” and “STVU” as shown) and storing the scan start signals in the address channels according to clock pulse signals CLK and signals of data transmission direction U_D, wherein “D” and “U” represent the direction of the data transmission that corresponds the U_D. The enable selecting unit 720 is adapted for determining whether to transfer the data stored in the shift register 710 to the level shifter 730, the multiplexer 740 and the output buffer 750 in sequence or not, according to an enable signal OE. The level shifter 730 is adapted for shifting voltage level of the received signals and transferring the data to the output buffer 750 via the multiplexer 740. In the figure, V_{SAH} and V_{SAL} shown respectively represent the value of high-level voltage and the value of low-level voltage transferred to the select line San, and V_{SBH} and V_{SBL} respectively represent the value of high-level voltage and the value of low-level voltage transferred to the select line SBn.

In summary, the present invention provides a new driving method for balancing the asymmetric polarities of conventional pixel voltages and efficiently eliminating the flicker phenomenon caused by the conventional driving method.

Other modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A driving method, adapted for a matrix driving display, wherein the matrix driving display comprises a plurality of pixels arranged in a matrix, each of the pixels being selectively driven by a first select line and a second select line, data to be displayed being transferred via a data line; the driving method comprising:
alternately changing polarities of voltages respectively applied to the first select line and the second select line when a polarity of a voltage applied to the data line is updated for each frame, wherein the polarities of the voltages respectively applied to the first select line and the second select line are complementary.

2. The driving method according to claim 1, wherein alternately changing polarities of voltages respectively applied to the first select line and the second select line is performed according to a predetermined rule.

3. The driving method according to claim 2, wherein the predetermined rule is to change the polarities of the voltages applied within a specific number of frame times.

4. The driving method according to claim 1, wherein alternately changing polarities of voltages respectively applied to the first select line and the second select line is performed in a random manner.

5. The driving method according to claim 4, wherein the random manner is to change the polarities of the voltages applied within a random number of frame times.

6. The driving method according to claim 1, wherein the voltages applied to all of the first select lines of an identical frame is positive or negative in polarity, and the polarities of the voltages respectively applied to the first select line and the second select line are complementary.

7. The driving method according to claim 1, wherein alternatively changing polarities of the voltages applied to all of the first select lines of an identical frame is performed according to a predetermined rule, and the polarities of the voltages respectively applied to the first select line and the second select line are complementary.

8. The driving method according to claim 7, wherein the predetermined rule is to change the polarities of the voltages applied within a specific number of row times.

9. The driving method according to claim 1, wherein alternatively changing polarities of the voltages applied to all of the first select lines of an identical frame are performed according to a random manner, and the polarities of the voltages respectively applied to the first select line and the second select line are complementary.

10. The driving method according to claim 9, wherein the random manner is to change the polarities of the voltages applied within a random number of row times.

11. The driving method according to claim 1, wherein the polarity of the voltage applied to the first select line is positive if the data voltage applied to the data line is positive, and the polarity of the voltage applied to the first select line is negative if the data voltage applied to the data line is negative, so as to complement the polarities of the voltages respectively applied to the first select line and the second select line.

12. The driving method according to claim 1, wherein the polarity of the voltage applied to the first select line is negative if the data voltage applied to the data line is positive, and the polarity of the voltage applied to the first select line is positive if the data voltage applied to the data line is negative, so as to complement the polarities of the voltages respectively applied to the first select line and the second select line.

13. A driving method, adapted for driving a pixel via a first select line and a second select line, comprising:
alternately changing the polarities of the voltages respectively applied to the first select line and the second select line when the polarities are updated in each frame, so as to complement the polarities of the voltages respectively applied to the first select line and the second select line.

14. The driving method according to claim 13, wherein a predetermined rule is followed to change the polarities of the voltages respectively applied to the first select line and the second select line.

15. The driving method according to claim 14, wherein the predetermined rule is to change the polarities of the applied voltages within a certain number of frame times.

16. The driving method according to claim 13, wherein the polarities of the voltages respectively applied to the first select line and the second select line are changed in a random manner.

17. The driving method according to claim 16, wherein the random manner is to change the polarities of the applied voltages within a random number of frame times.

18. A driving circuit for a matrix driving display, the driving circuit being connected with a display panel, wherein the display panel comprises a plurality of pixels arranged in a form of a matrix, each of the pixels being selectively driven by a first select line and a second select line, the display data being transferred to the pixel via a data line;
the driving circuit comprising:
a shift register, having a plurality of address channels adapted for receiving scan signals and storing the scan signals in the address channels according to a timing pulse signal;
an enable selecting unit, adapted for receiving an enable signal and thereby transferring the scan data stored in the address channels of the shift register;
a level shifter, connected with the enable selecting unit for receiving the transferred scan data from the address channels of the shift register and processing level shifting process;
a multiplexer, adapted for selectively outputting the level shifted scan data from the level shifter; and
an output buffer, adapted for receiving the level shifted scan data from the multiplexer and driving the pixel via a first select line and a second select line corresponding to the pixel, wherein the polarities of the voltages respectively applied to the first select line and the second select line can be alternately changed when the polarities of each frame is updated, so as to complement the polarities of the voltages respectively applied to the first select line and the second select line.

19. The driving circuit for a matrix driving display according to claim 18, wherein a predetermined rule is followed to change the polarities of the voltages respectively applied to the first select line and the second select line.

20. The driving circuit for a matrix driving display according to claim 19, wherein the predetermined rule is to change the polarities of the applied voltages within a certain magnitude of frame times.

21. The driving circuit for a matrix driving display according to claim 18, wherein the polarities of the voltages respectively applied to the first select line and the second select line are changed in a random manner.

22. The driving circuit for a matrix driving display according to claim 21, wherein the random manner is to change the polarities of the applied voltages within a random number of frame times.

23. The driving circuit for a matrix driving display according to claim 18, wherein the polarities of the voltages applied to all of the first select lines of an identical frame are positive or negative, so as to complement the polarities of the voltages respectively applied to the first select line and the second select line.

24. The driving circuit for a matrix driving display according to claim 18, wherein alternatively changing polarities of the voltages applied to all of the first select lines of an identical frame is performed according to a predetermined rule, so as to complement the polarities of the voltages respectively applied to the first select line and the second select line.

25. The driving circuit for a matrix driving display according to claim 24, wherein the predetermined rule is to change the polarities of the voltages applied within a specific number of row times.

26. The driving circuit for a matrix driving display according to claim 18, wherein alternatively changing polarities of the voltages applied to all of the first select lines of an identical frame are performed according to a random manner, so as to complement the polarities of the voltages respectively applied to the first select line and the second select line.

27. The driving circuit for a matrix driving display according to claim 26, wherein the random manner is to change the polarities of the voltages applied within a random number of row times.

28. The driving circuit for a matrix driving display according to claim 18, wherein he polarity of the voltage applied to the first select line is positive if the data voltage applied to the data line is positive, and the polarity of the voltage applied to the first select line is negative if the data voltage applied to the data line is negative, so as to complement the polarities of the voltages respectively applied to the first select line and the second select line.

29. The driving circuit for a matrix driving display according to claim 18, wherein the polarity of the voltage applied to the first select line is negative if the data voltage applied to the data line is positive, and the polarity of the voltage applied to the first select line is positive if the data voltage applied to the data line is negative, so as to complement the polarities of the voltages respectively applied to the first select line and the second select line.
